(19) United States
(12) Patent Application Publication
(10) Pub. No.: US 2012/0266406 A1
(43) Pub. Date: Oct. 25, 2012

(54) WINDSHIELD WIPER DEVICE IN A VEHICLE

(75) Inventor: Godelieve Kraemer, Huegelsheim (BE)

(73) Assignee: ROBERT BOSCH GmbH, Stuttgart (DE)

(21) Appl. No.: 13/504,554

(22) PCT Filed: Oct. 7, 2010
(86) PCT No.: PCT/EP2010/065017

§ 371 Date: Jul. 9, 2012

(30) Foreign Application Priority Data
Oct. 29, 2009 (DE) 102009046153.1

(51) Int. Cl. B60S 1/34

(52) U.S. Cl. 15/250.351

(57) ABSTRACT

The invention relates to a windshield wiper device in a vehicle, comprising a wiper arm supported by means of a joint, wherein the joint comprises a bushing for receiving a bearing shaft. The bushing can be inserted in a recess in a fastening part and is made of plastic, wherein at least one deformation element for adapting the outer diameter is adapted to the bushing wall.

### BACKGROUND OF THE INVENTION

The invention relates to a windshield wiper device in a vehicle.

Windshield wiper devices, which are used to clean the front windshield or rear window pane, comprise a wiper arm, which is mounted in an articulated manner on a wiper shaft and executes a rotating pendulum movement about the joint arrangement via the drive of a windshield wiper linkage. Steel bushings, in which the wiper shaft is pivotally accommodated, are used in the region of the joint arrangement in order to absorb the bearing forces over a long operating period without limitation of the wiper operation, wherein the inside of the bushings can be provided with a coating for reducing friction. The bushing is typically inserted in a fastening part, which is embodied as a cast part, of the wiper linkage, wherein the bore usually has to be reworked during the manufacture of the cast part in order to receive the steel bushing. A reworking of the bores in the fastening part is also required in the case of a fastening part made from sheet metal for receiving the bushing.

### SUMMARY OF THE INVENTION

The underlying aim of the invention is to implement a windshield wiper device in a vehicle using simple measures in order that the wiping motion of the wiper arm can be executed over a long operating period without compromising the wiper operation.

The inventive windshield wiper device is used in a vehicle, in particular for wiping the windshield or the rear window pane of the vehicle. The windshield wiper device comprises a wiper arm supported by means of a joint, which executes a wiping motion upon actuating said device, wherein the joint of the wiper arm comprises a bushing for receiving a wiper shaft or respectively bearing shaft. The bearing shaft is typically disposed on the wiper arm and is rotatably mounted within the bushing, wherein said bushing can be inserted into a recess of a fastening part, said fastening part being preferably disposed so as to be fixed to the vehicle or rather the vehicle body.

Provision is made according to the invention for the bushing to be made of plastic and for at least one deformation element for the radial adaptation of the outer diameter of said bushing to be integrally formed on the bushing wall. The plastic design has different advantages, namely the cost effective and easy manufacturability, the low weight, the low friction of the bearing shaft being received as well as a deformation capability within defined limits, which can be used for radially adapting the outer diameter of said bushing in the region of the deformation element which is integrally designed with the bearing wall. The deformation capability of said bushing, which is achieved by the selection of material as well as the structural design of said deformation element on the bearing wall, permits said bushing to be pressed into the recess in the fastening part, wherein the bearing wall is radially deformed during the press-fit process, in particular the radial outer diameter of said bushing is reduced at least in sections. Due to the deformability of the outer wall of said bushing, a complicated reworking of the recess in the fastening part can be eliminated. This represents a considerable simplification of the manufacturing process and thereby a cost effective embodiment.

The bushing consists advantageously of a heat resistant plastic, which also at higher temperatures displays no significant deformations due to relaxation. It is thus ensured that the plastic bushing retains the original form thereof even when the windshield wiper device parts are subjected to the high temperatures prevailing in an enameling line. The reduction of the outer diameter is solely achieved by mechanical forces when press-fitting the plastic bushing into the recess in the fastening part. The selection of material is furthermore a factor in ensuring that a low friction accommodation of the bearing shaft is guaranteed without coating the plastic inner surface of the bushing.

The plastic bushing can be manufactured by a spray or extrusion process and can be designed either as a single material component or as a multiple material component.

According to a preferred embodiment, the bushing has a modified wall thickness in the region of the deformation element. A raised section that projects radially beyond the outer jacket of the bushing and forms the deformation element can, for example, be configured on said outer jacket. This raised section advantageously extends over a narrowly defined angular segment and is, for example, designed as a knob-like or triangular-shaped raised section. With the insertion of the bushing in the recess, said raised section has a force applied to it inwardly in the radial direction, whereby the material of the deformation element is deformed and radially flattened.

The inner material of the bushing is advantageously designed to have a smooth surface without any through holes or raised sections. Nevertheless it can be advantageous according to a further embodiment variant for recesses to be provided over a defined angular segment on the inner jacket. The recesses particularly extend in the axial direction and are, for example, configured as grooves so that the inner jacket has at least a slightly larger diameter at the location of the recess. Raised sections projecting radially upwards, which form the deformation elements, are advantageously situated on the outside of the bushing in this embodiment variant; thus enabling an approximately constant wall thickness to be by and large achieved.

According to a further advantageous embodiment, the deformation element is configured as a notch on the outer jacket of the bushing wall, the wall thickness of said bushing wall being at least slightly reduced at this location by means of the notch. Said notch facilitates a diameter reduction when the bushing is pressed into the associated recess in the fastening part of the windshield wiper device. It can be advantageous here for said notch to extend in the tangential direction, wherein the wall of the bushing, which outwardly delimits said notch in the radial direction, can radially deform, in particular can be bent inwardly.

Additionally or alternatively it is also possible for the notch to extend in the radial direction without tangential components, wherein walls on the bushing, which laterally delimit the notch, can radially deform when a corresponding application of force occurs while pressing the bushing into the recess.

The notch extends preferably in the radial direction only over a part of the wall thickness of the bushing so that the notch does not run completely through the bushing wall. This has the advantage that the stability of said bushing is not or at least not significantly reduced and that an optimal mounting of the bearing shaft that is received on the inside of said bushing is ensured. Nevertheless it can however be useful to provide notches in the region of an end face of said bushing, which run completely through the wall in the radial direction. This improves the radial deformation of said bushing in this region. If need be, such notches are provided in the region of both end faces.

The notches extend just as the radial raised sections on the outside of the bushing, either only over an axial partial length of said bushing or else over the entire axial length of said bushing. It is also possible that provision is made on the one hand for a plurality of deformation elements to be distributed over the periphery of said bushing and on the other hand as viewed in the axial direction of said bushing for a plurality of deformation elements to be provided, which in each case extend only over an axial partial length.

Provision is made according to a further advantageous embodiment for the bushing to have a variable outer diameter over the axial length thereof irrespective of the deformation elements, which are integrally formed on the outer jacket of said bushing. In this embodiment, said outer jacket preferably has a conical form, whereas said bushing has a cylindrical form in the case of an embodiment having a constant radius.

### BRIEF DESCRIPTION OF THE DRAWINGS

Further advantages and advantageous embodiments are found in the additional claims, the description of the figures and in the drawings. The following are shown:

FIG. 1 a side view of a wiper arm of a windshield wiper device, wherein the wiper arm is connected in an articulated manner to a fastening part by means of a joint,

FIG. 2 a detail drawing in the region of the articulated mounting of the wiper arm,

FIG. 3 a sectional view in accordance with the cutting line III-III from FIG. 2,

FIG. 4 a cross section through a bushing comprising knob-like, radial raised sections on the outer jacket,

FIG. 5 a cross section through a bushing having tangential notches,

FIG. 6 a cross section through a bushing having knob-like raised section son the outside and grooves disposed at the identical location on the innerjacket,

FIG. 7 a cross section through a bushing having two opposing radial notches in the region of the outer jacket,

FIG. 8 a cross section through a bushing having triangular-shaped raised sections on the outer jacket,

FIG. 9 a longitudinal cross section through a cylindrical bushing,

FIG. 10 a longitudinal cross section through a bushing having a partially conical outer jacket,

FIG. 11 a bushing consisting of two component parts having in each case a radially widened collar on the end face thereof,

FIG. 12 a longitudinal cross section through a bushing having radial notches introduced in the region of the two axial end faces,

FIG. 13 a view of the end face of the bushing pursuant to FIG. 12.

### DETAILED DESCRIPTION

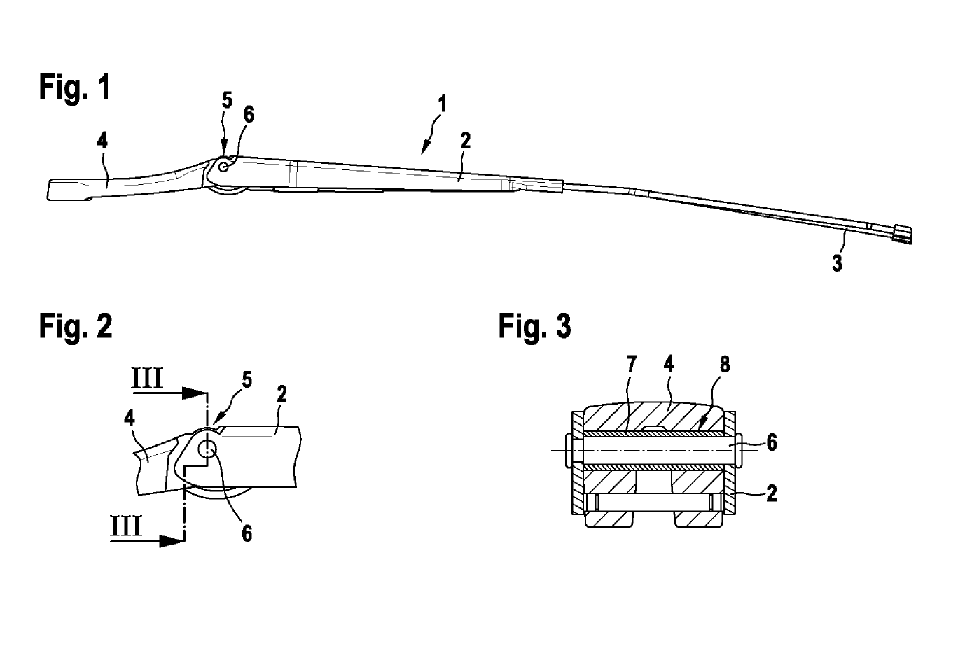

FIG. 1 shows a cut-out of a windshield wiper device 1 in a vehicle for wiping the windshield or the rear window pane. The windshield wiper device 1 comprises a wiper arm 2, which is the carrier of a wiper blade 3 and is coupled in a rotationally displaceable manner by means of a joint 5 to a fastening part 4 of said windshield wiper device 1. The fastening part 4 is particularly mounted in said windshield wiper device 1 so as to be fixed to the vehicle or rather the vehicle body.

As can be seen in FIG. 1 in connection with FIG. 2 and FIG. 3, the joint 5 comprises a wiper or respectively bearing shaft 6, which is rotatably mounted in a bushing 7. The bearing shaft 6 is fixedly connected to the wiper arm 2, the bushing 7 is accommodated in a recess 8, which is introduced into the fastening part 4 in the region of said joint 5. Said fastening part 4 is, for example, embodied as a cast part, whereas said bushing 7 is made of plastic, in particular of heat resistant plastic.

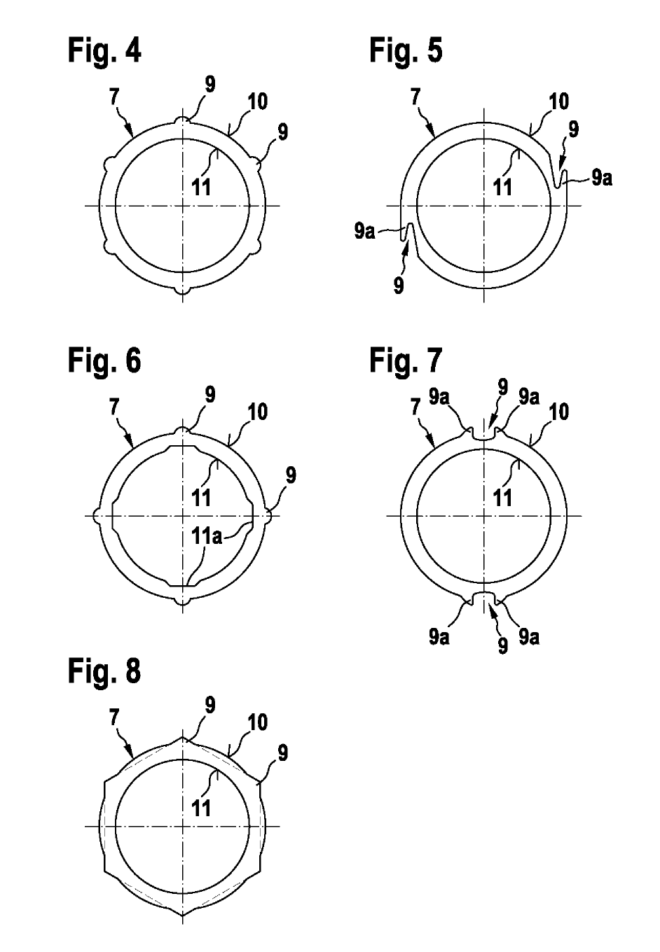

Different embodiment variants of plastic bushings 7 are depicted in FIGS. 4 to 8 in cross section perpendicular to the longitudinal axis. Pursuant to FIG. 4, a plurality of deformation elements 9 in the form of knob-like raised sections is integrally formed on the outer jacket 10 of the bushing 7 so as to be distributed on the outer periphery of the same. In total, provision is made for six knob-like raised sections 9, which are disposed at equal angular distances, to be distributed over the periphery. The knob-like raised sections 9 ascend radially outwards with respect to said outer jacket 10, wherein the radial overhang is smaller than the wall thickness of said bushing 7 and, for example, amounts to not more than the half or a third or a fourth of the wall thickness of said bushing. The deformation elements 9 are integrally formed on said bushing during the manufacturing process thereof using an extrusion or injection molding procedure.

In the exemplary embodiment pursuant to FIG. 5, the deformation elements 9 form notches, which run in the tangential direction, in the wall of the bushing, whereby radially outer projections 9a are formed in the bushing wall, which if need be can protrude slightly in the radial direction beyond the outer jacket 10. When pressed into a recess in the fastening part, the projections 9a are pressed radially inwards. Provision is made in total for two diametrically opposed deformation elements 9 in the form of a tangential notch.

In the exemplary embodiment pursuant to FIG. 6, the deformation elements 9 like in the exemplary embodiment pursuant to FIG. 4 are integrally formed on the outer jacket 10 as knob-like raised sections. Provision is made in total for four knob-like raised sections to be distributed over the periphery. The inner jacket 11 deviating from the other smooth surfaced embodiment is provided with grooves 11a, which are disposed opposite to the knob-like raised sections. This results in an at least approximately uniform wall thickness over the periphery of the bushing 7.

In the exemplary embodiment pursuant to FIG. 7 and analogous to FIG. 5, two diametrically opposed deformation elements 9 in the form of notches are provided, which however extend in the radial direction. Each notch is bounded by two projections 9a, which radially ascend above the jacket surface 10.

In the exemplary embodiment pursuant to FIG. 8, a plurality of raised sections 9 are integrally formed on the outer jacket 10 and evenly spaced around the periphery. Said raised sections project radially beyond said outer jacket 10 have, however, in contrast to the exemplary embodiment pursuant to FIG. 4 or FIG. 6 a triangular-shaped profile.

In all of the aforementioned exemplary embodiments, the deformation elements 9 can axially extend either over the entire axial length of the bushing 7 or over an axial partial length.

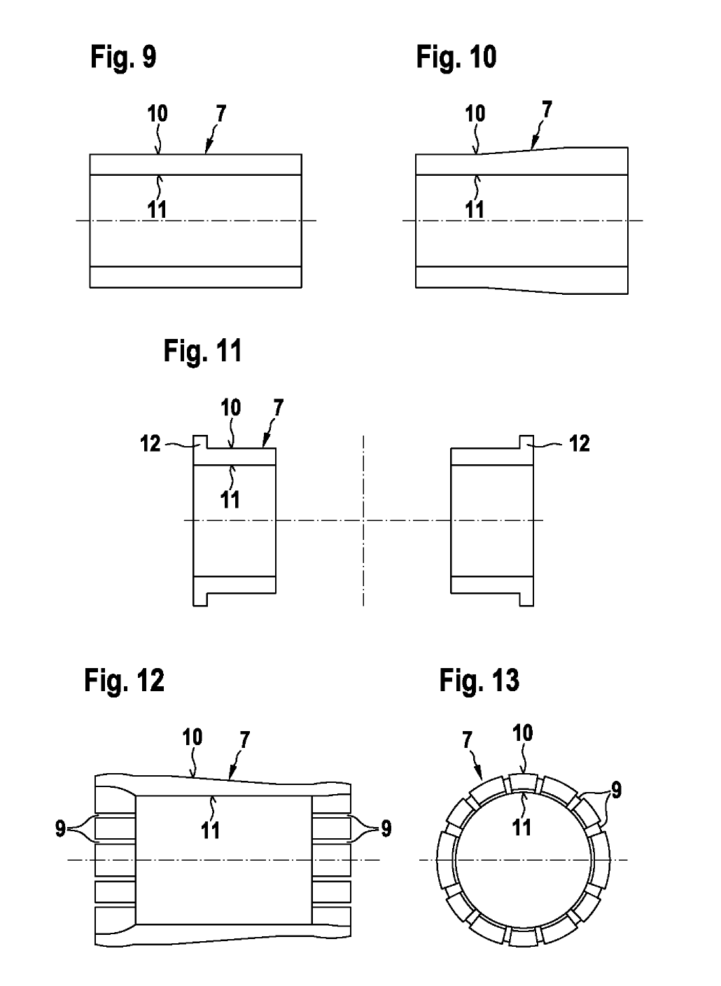

In FIGS. 9, 10 and 11, a bushing 7 is in each case depicted in a longitudinal cross section. Pursuant to FIG. 9, the bushing 7 is embodied as a hollow cylinder having an inner diameter which remains constant across the axial length and a constant outer diameter.

Pursuant to FIG. 10, the bushing 7 has only a constant inner diameter, whereas the outer diameter is designed to vary in sections, in particular designed to be conical. The conical section extends spaced apart from the end face regions, in which the outer diameter is cylindrically formed.

In FIG. 11, the bushing is designed as two parts, wherein the two bushing parts are arranged mirror-symmetrically with respect to one another. Each bushing part has a radially widened collar on an end face thereof.

In the exemplary embodiment pursuant to FIGS. 12 and 13, the bushing 7 has deformation elements 9 in the form of notches extending in the axial direction in the region of both end faces, said notches extending completely through the bushing wall. A good radial deformability is thereby provided in the region of the end faces. The deformation elements 9 starting from the end faces extend only over an axial partial length.

The outer diameter is not constant over the axial length but is conically designed in the intermediate region outside of the notches 9. In the region of the end faces, which comprise said notches 9, the outer jacket is of cylindrical design.

1. A windshield wiper device for a vehicle, comprising a wiper arm (2) supported by means of a joint, characterized in that the joint (5) of the wiper arm (2) comprises a bushing (7) for receiving a bearing shaft (6), wherein the bushing (7) can be inserted in a recess (8) in a fastening part (4) and is made of plastic and at least one deformation element (9) for radially adapting an outer diameter of said bushing (7) is integrally formed on a bushing wall.

2. The windshield wiper device according to claim 1, characterized in that the bushing (7) has a modified wall thickness in a region of the deformation element (9).

3. The windshield wiper device according to claim 1, characterized in that the deformation element (9) is designed as a raised section, which projects radially beyond an outer jacket (10) of the bushing (7).

4. The windshield wiper device according to claim 1, characterized in that the deformation element (9) is designed as a notch in the bushing wall.

5. The windshield wiper device according to claim 4, characterized in that the notch runs in a tangential direction.

6. The windshield wiper device according to claim 4, characterized in that the notch extends in a radial direction.

7. The windshield wiper device according to claim 4, characterized in that the notch extends in an axial direction.

8. The windshield wiper device according to claim 4, characterized in that the notch runs completely through the bushing wall.

9. The windshield wiper device according to claim 8, characterized in that the notch is arranged adjacent to an end face of the bushing (7).

10. The windshield wiper device according to claim 1, characterized in that a plurality of deformation elements (9) are distributed over the periphery.

11. The windshield wiper device according to claim 1, characterized in that the bushing (7) has a variable outer diameter over the axial length thereof.

12. The windshield wiper device according to claim 1, characterized in that an inner jacket (11) of the bushing is a smooth surface over an axial partial length.

13. (canceled)

14. The windshield wiper device according to claim 1 wherein an inner jacket of the bushing has therein a groove opposite the deformation element.

15. The windshield wiper device according to claim 10 wherein an inner jacket of the bushing has therein a groove opposite each of the deformation elements.

16. A windshield wiper device for a vehicle, the device comprising a wiper arm, a fastening part, and a joint supporting the wiper arm relative to the fastening part, the joint including a bushing receiving a bearing shaft, the bushing being received in a recess in the fastening part, and the bushing being made of plastic and having at least one deformation element integrally formed on an outer surface of a bushing wall.
